(19) United States
(12) Patent Application Publication
(10) Pub. No.: US 2007/0044614 A1
(43) Pub. Date: Mar. 1, 2007

(54) Sawing machine

(75) Inventor: Cheng-Hung Chiu, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Rexon Industrial Corp., Ltd., Taichung Hsien (TW)

(21) Appl. No.: 11/488,773

(22) Filed: Jul. 19, 2006

(30) Foreign Application Priority Data
Aug. 30, 2005 (TW) 94129746

(51) Int. Cl. B23D 45/06

(52) U.S. Cl. 83/473; 83/477.2

(57) ABSTRACT

A sawing machine includes a worktable having a working surface, a mounting frame holding a rotary saw blade of the sawing machine and driving the rotary saw blade to rotate, an adjusting device operable to bias the mounting frame so as to change an angle between the saw blade and the working surface, an angle indicator having an index zone exposed onto the working surface for indicating the angle between the saw blade and the working surface, and a connecting member having two ends coupled respectively to a non-pivotal point of the mounting frame and the angle indicator for moving the angle indicator relative to the working surface when the mounting frame is rotated relative to the worktable.

### BACKGROUND OF THE INVENTION

1. Field of the Invention

The present invention relates to a sawing machine, and more particularly to a sawing machine having an angle indicator for showing a cutting angle of a saw blade.

2. Description of the Related Art

FIGS. 5 and 6 show a conventional circular sawing machine 90, which comprises a worktable 92, a base 94 supporting the worktable 92, a mounting frame 96 pivotally mounted in the base 94, and a saw blade 98 held by the mounting frame 96. When the mounting frame 96 is rotated, the saw blade 98 is biased relative to the worktable 92. Therefore, the worker can adjust the angle of the saw blade 98 relative to the worktable 92 to perform different cutting operations in different cutting angles subject to different requirements.

Further, the front wall of the base 94 is opened with an arched slot 942 and marked with graduations 944 along one side of the arched slot 942. The mounting frame 96 has a pointer 962 inserted through the arched slot 942. The pointer 962 is movable with the mounting frame 96 along the arched slot 942. When the saw blade 98 is biased relative to the worktable 92, the pointer 962 is moved correspondingly along the arched slot 942, thereby indicating the biasing angle of the saw blade 98.

Because the arched slot 942 is formed in the front wall of the base 94 below the worktable 92, and the cutting zone of the saw blade 98 is on the top side of the worktable 92, the worker cannot know the real cutting angle of the saw blade 98 by visually checking the graduation 944 indicated by the pointer 962 from his/her normal working position. In other words, a worker who stands as a normal working position will not know the real-time cutting angle of the saw blade unless bending the his/her waist down. This is not rapid and convenient for the worker to set the saw blade 98 at a desired cutting angle and check the cutting angle.

### SUMMARY OF THE INVENTION

The present invention has been accomplished under the circumstances in view. It is the objective of the present invention to provide a sawing machine, which has an angle indicator for indicating the cutting angle of the saw blade relative to the working surface of the worktable. The angle indicator has an index zone exposed onto the working surface of the worktable so that the worker can keep normal working position to directly read out the indication of the angle indicator during working for knowing the cutting angle of the saw blade.

To achieve this objective of the present invention, the sawing machine comprises a worktable, a rotary saw blade, a mounting frame, an adjusting device, an angle indicator, and a connecting member. The worktable has a working surface. The mounting frame holds the rotary saw blade and drives the rotary saw blade to rotate. The adjusting device is operable to bias the mounting frame so as to change an angle between the saw blade and the working surface. The angle indicator has an index zone exposed onto working surface for indicating the angle between the saw blade and the working surface. The connecting member has two ends coupled respectively to a non-pivotal point of the mounting frame and the angle indicator for moving the angle indicator relative to the working surface when the mounting frame is rotated relative to the worktable.

In an embodiment of the present invention, the worktable is provided with a guide defining a holding space in which the angle indicator is moveably received, such that the angle indicator is movable relative to the working surface in a substantially horizontal direction. In addition, the worktable has a through hole facing the angle indicator such that the index zone of the angle indicator is exposed through the through hole.

### BRIEF DESCRIPTION OF THE DRAWINGS

FIG. 1 is a schematic drawing showing a sawing machine according to a preferred embodiment of the present invention.

FIG. 2 is a sectional view taken along line 2-2 of FIG. 1.

FIG. 3 is an enlarged view of part A of FIG. 2.

FIG. 4 is similar to FIG. 1 but showing the saw blade biased relative to the worktable.

FIG. 5 is a perspective view of a circular sawing machine according to the prior art.

FIG. 6 is a schematic drawing showing the internal structure of the circular sawing machine according to the prior art.

### DETAILED DESCRIPTION OF THE INVENTION

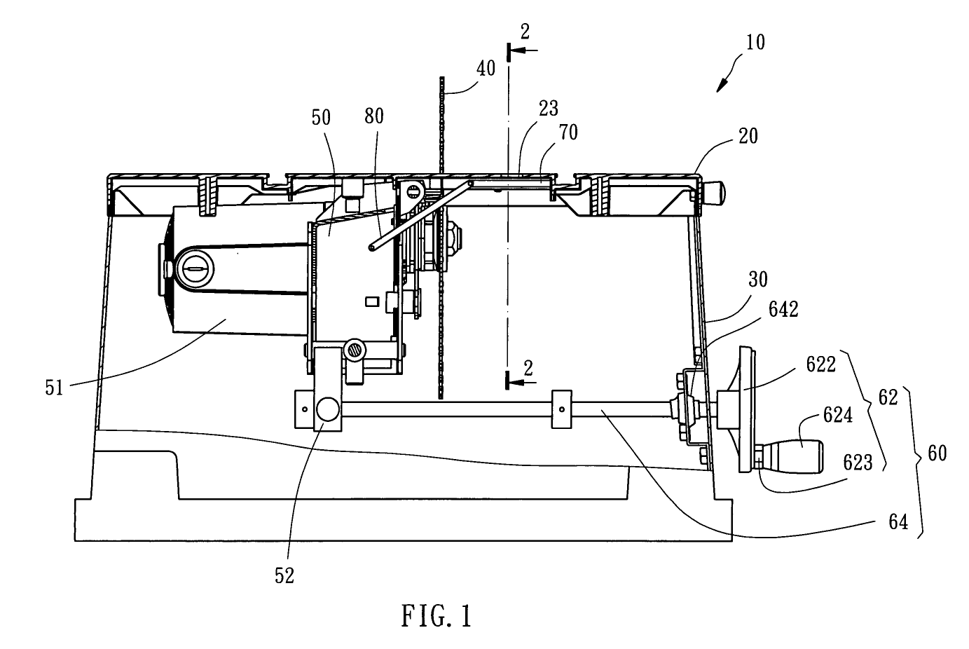

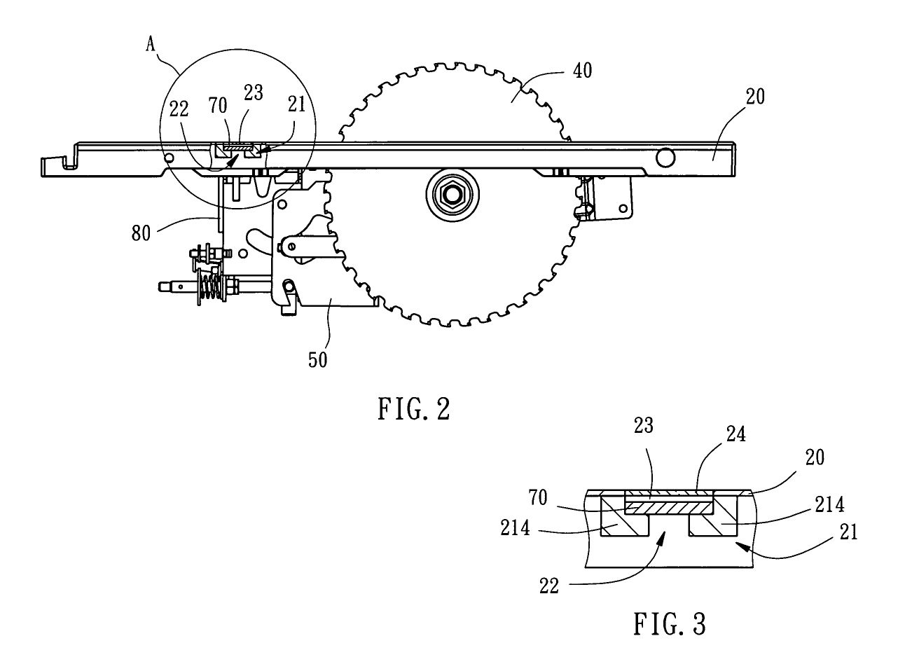

As shown in FIGS. 1-3, a sawing machine 10 such as a table saw in accordance with the preferred embodiment of the present invention comprises a worktable 20, a base 30, a rotary saw blade 40, a mounting frame 50, an adjusting device 60, an angle indicator 70, and a connecting member 80.

The worktable 20 is a metal platform having a flat working surface for holding a workpiece. The worktable 20 has a cutting slot (not shown) through which the saw blade 40 extends, a guide 21 provided at the bottom side thereof, a through hole 23 therethrough a pointer (not shown) disposed on the working surface near the through hole 23, and a transparent cover 24 covering the through hole 23. The guide 21 has two L-shaped hooks 214 each having one end affixed to the bottom side of the worktable 20 and the other end facing the other hook's. The two L-shaped hooks 214 define a holding space 22 therebetween.

The base 30 is provided at the bottom side of the worktable 20 to support the worktable 20. The saw blade 40 is a metal blade extending through the cutting slot of the worktable 20 for cutting the workpiece. The mounting frame 50 is a metal member pivotally connected to the worktable 20 and received inside the base 30. The saw blade 40 is rotatable by a driving device, such as a motor 51, of the mounting frame 50. Further, the mounting frame 50 is provided with a nut 52.

The adjusting device 60 includes a rotary operating device 62 and a threaded rod 64. The rotary operating device 62 has a wheel 622, a stem 623 perpendicularly extending from one side of the wheel 622 near the border of the wheel 622, and a grip 624 rotatably coupled to the stem 623. The threaded rod 64 has a first end part screwed through the nut 52 of the mounting frame 50 and a second end part connected fixedly to the center of the wheel 622 through a universal joint 642 and the base 30. The universal joint 642 is located on and inside the base 30. When moving the grip 624 ringedly to rotate the wheel 622, the threaded rod 64 is synchronously rotated with the wheel 622, thereby causing the nut 52 to move along the threaded rod 64 to further bias the mounting frame 50 relative to the flat working surface of the worktable 20. Therefore the saw blade 40 is biased relative to the flat working surface of the worktable 20.

The angle indicator 70 is mounted in the holding space 22 beneath the worktable 20, and movable horizontally relative to the flat working surface of the worktable 20. Further, the angle indicator 70 has a plurality of graduations marked on an index zone (not shown) at the top side thereof and facing the through hole 23 of the worktable 20 so that the index zone of the angle indicator 70 is exposed from the through hole 23 of the worktable 20. The pointer at the border of the through hole 23 can point out one of the graduations of the angle indicator 70 corresponding to the angle of the saw blade 40 relative to the flat working surface of the worktable 20.

The connecting member 80 is a straight rod, having one end pivotally connected to a part of the mounting frame 50 away from the pivotal point between the mounting frame 50 and the worktable 20 and the other end pivotally connected to one end of the angle indicator 70. When biasing the mounting frame 50, the connecting member 80 is driven to move the angle indicator 70 in the holding space 22.

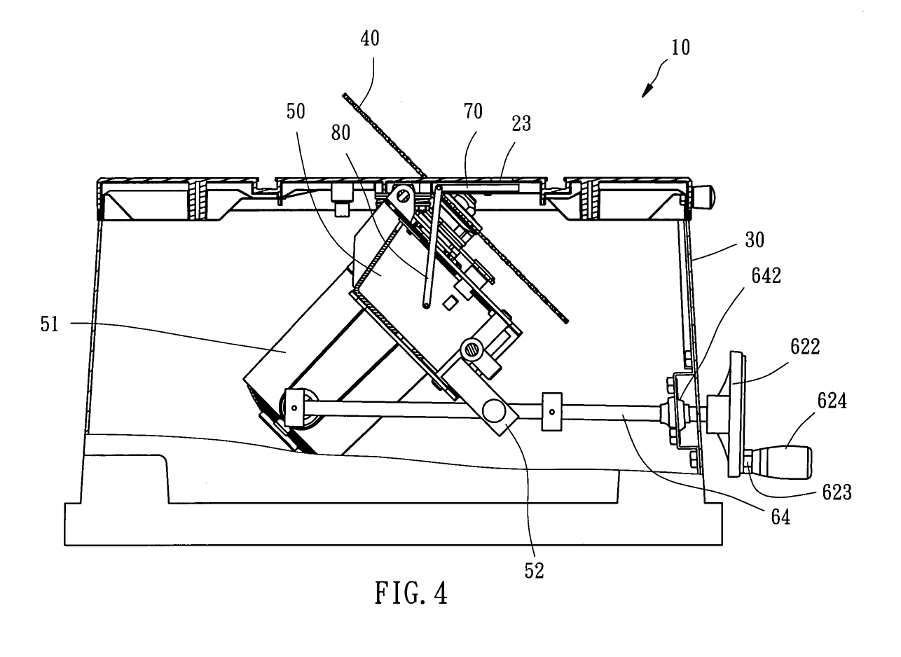

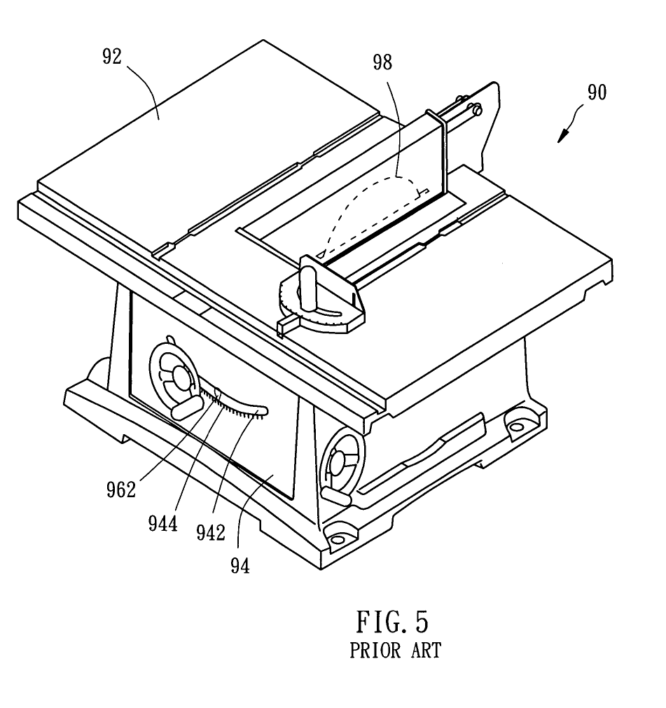

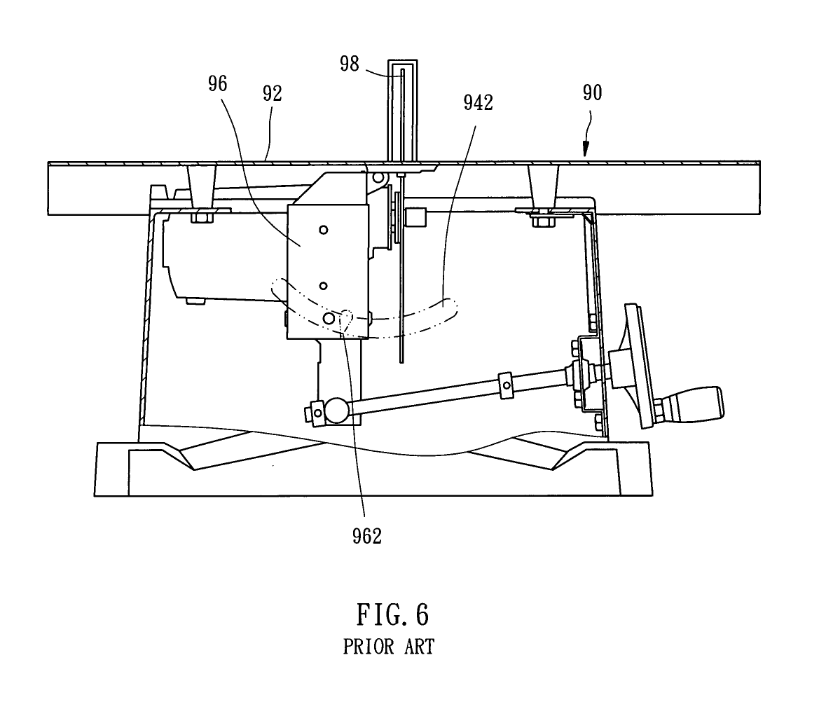

Referring to FIG. 4, when adjusting the cutting angle of the saw blade 40, the worker operates the grip 624 to rotate the wheel 622 clockwise to cause synchronous rotation of the threaded rod 64 with the wheel 622, and thereby the mounting frame 50 is rotated counter-clockwise. At the same time, the mounting frame 50 biases the saw blade 40 and moves the connecting member 80 to pull the angle indicator 70 toward the saw blade 40. On the contrary, when the worker operates the grip 624 to rotate the wheel 622 in the reversed (counter-clockwise) direction, the mounting frame 50 is rotated clockwise to move the connecting member 80 to push the angle indicator 70 away from the saw blade 40. By the through hole 23, the worker can read the graduation on the angle indicator 70 pointed out by the point to know the current angle of the saw blade 40 relative to the flat working surface of the worktable 20 during the cutting work. Moreover, in case the saw blade 40 is deviated from the desired cutting angle accidentally by an external force during the cutting work, the worker can know the situation by viewing the angle indicator 70 through the through hole 23 with his/her normal working position. In general, by means of the aforesaid simple structure, the worker can visually check the cutting angle of the saw blade 40 conveniently during the cutting work.

In an alternate form of the present invention, the graduations is marked directly on the working surface (top side) of the worktable 20 adjacent to the through hole 23, and the pointer is provided on the index zone of the angle indicator 70 for pointing out one of the graduations.

Although the particular embodiments of the invention have been described in detail for purposes of illustration, various modifications and enhancements may be made without departing from the spirit and scope of the invention. Accordingly, the invention is not to be limited except as by the appended claims.

What is claimed is:

1. A sawing machine comprising:
a worktable having a working surface;
a rotary saw blade;
a mounting frame holding the rotary saw blade and driving the rotary saw blade to rotate, wherein the mounting frame is rotatable relative to the working surface;
an adjusting device rotating the mounting frame relative to the working surface so as to change an angle between the saw blade and the working surface;
an angle indicator having an index zone for indicating the angle between the saw blade and the working surface; and
a connecting member having two ends coupled respectively to a non-pivotal point of the mounting frame and the angle indicator for moving the angle indicator relative to the working surface when the mounting frame is rotated relative to the worktable.

2. The sawing machine as claimed in claim 1, wherein the angle indicator is movably mounted to the worktable.

3. The sawing machine as claimed in claim 2, wherein the worktable has a guide defining a holding space in which the angle indicator is moveably disposed such that the angle indicator is movable in a substantially horizontal direction relative to the working surface.

4. The sawing machine as claimed in claim 2, wherein the angle indicator is disposed at one side of the worktable opposite to the working surface of the worktable, and the worktable has a through hole facing the angle indicator such that the index zone of the angle indicator is exposed through the through hole.

5. The sawing machine as claimed in claim 4, wherein the through hole is covered with a transparent cover.

6. The sawing machine as claimed in claim 4, wherein the index zone of the angle indicator has a plurality of graduations marked thereon, and the worktable has a pointer marked on the working surface adjacent to the through hole for pointing out one of the graduations at the index zone.

7. The sawing machine as claimed in claim 4, wherein the worktable has a plurality of graduations marked on the working surface adjacent to the through hole, and the index zone of the angle indicator has a pointer marked thereon for pointing out one of the graduations.

8. The sawing machine as claimed in claim 1, wherein the worktable has a cutting slot through which the saw blade extends.

9. The sawing machine as claimed in claim 1, further comprising a base supporting the worktable, wherein the mounting frame is pivotally mounted inside the base.

10. The sawing machine as claimed in claim 1, the sawing machine is a table saw.

11. The sawing machine as claimed in claim 1, wherein the adjusting device comprises a rotary operating member and a threaded rod, the threaded rod having a first end screwingly coupled to the mounting frame and a second end connected to the rotary operating member for biasing the mounting frame relative to the working surface upon rotation of the rotary operating member.

12. The sawing machine as claimed in claim 1, wherein the connecting member is a straight rod having two ends pivotally connected to the mounting frame and the angle indicator respectively.

13. A sawing machine comprising:
a worktable having a working surface and a guide defining a holding space;
a rotary saw blade;
a mounting frame holding the rotary saw blade and driving the rotary saw blade to rotate, wherein the mounting frame is rotatable relative to the working surface;
an adjusting device rotating the mounting frame relative to the working surface so as to change an angle between the saw blade and the working surface;
an angle indicator having an index zone for indicating the angle between the saw blade and the working surface, and disposed in guide to be movable in a substantially horizontal direction relative to the working surface; and
a connecting member having two ends coupled respectively to a non-pivotal point of the mounting frame and the angle indicator for moving the angle indicator relative to the working surface when the mounting frame is rotated relative to the worktable.

14. A sawing machine comprising:
a worktable having a working surface and a through hole;
a rotary saw blade;
a mounting frame holding the rotary saw blade and driving the rotary saw blade to rotate, wherein the mounting frame is rotatable relative to the working surface;
an adjusting device rotating the mounting frame relative to the working surface so as to change an angle between the saw blade and the working surface;
an angle indicator having an index zone for indicating the angle between the saw blade and the working surface, and disposed at one side of the worktable opposite to the working surface of the worktable, wherein the angle indicator faces the through hole such that the index zone of the angle indicator is exposed through the through hole; and
a connecting member having two ends coupled respectively to a non-pivotal point of the mounting frame and the angle indicator for moving the angle indicator relative to the working surface when the mounting frame is rotated relative to the worktable.
